(19) United States
(12) Patent Application Publication
(10) Pub. No.: US 2018/0337841 A1
(43) Pub. Date: Nov. 22, 2018

(54) ENHANCED COMPONENT LATENCY TRACKING

(71) Applicant: Microsoft Technology Licensing, LLC, Redmond, WA (US)

(72) Inventors: Juan Pablo Muraira, Redmond, WA (US); James Clark Batchelder, Bellevue, WA (US); Song Yang, Woodinville, WA (US)

(21) Appl. No.: 15/600,112

(22) Filed: May 19, 2017

(51) Int. Cl. H04L 12/26

(52) U.S. Cl. CPC H04L 43/067; H04L 43/0852; H04L 43/0864; H04L 43/106; H04L 43/0858; H04L 43/087

(57) ABSTRACT

Systems, methods, and software technology for tracking component latency. A component tracking method records the start-times and end-times of components as they execute in furtherance of a request for a service. In addition, a dependency tracking method records the start-times and the end-times of one or more dependencies of the components, which may also be executed in furtherance of the requests. A latency of each component may be determined from its start-time and end-time, as well as the start-times and end-times of its dependencies. In some implementations, component latency may be analyzed on a per-request basis.

### TECHNICAL BACKGROUND

Latency investigation in the context of software development relates to finding out how long programs or their components take to run. This may be a routine part of the development process or may be undertaken when it becomes apparent that a program or a portion thereof is running slow.

Developers sometimes begin the process of investigating latency by instrumenting suspicious components to record timestamps when they start and end. The instrumented code can help to determine which component may be the culprit, but it can also be cumbersome to implement and difficult to reverse. In fact, the instrumented code itself may even add to latency if not removed.

More importantly, obtaining the timestamps on a given component may not provide a granular enough picture of what is going on inside of the component. As an example, a component may call its dependencies, which are other resources that the component depends on to accomplish a task. It may be the case with a component that appears slow that a dependency of the component is actually causing the slow down.

To mitigate this problem, a program may be further instrumented to an ever more granular level so as to capture the latencies of sub-components and dependencies of components. Unfortunately, this approach only acerbates the problem of having to initially implement and then later undo the instrumented code.

### OVERVIEW

Technology is disclosed herein that improves latency tracking for software components such that component latency may be analyzed without having to instrument individual components. Rather, tracking methods are invoked at the entry point to components and at the border between components and their dependencies.

In an implementation, a component tracking method records the start-times and end-times of components as they execute in furtherance of a request for a service. In addition, a dependency tracking method records the start-times and the end-times of one or more dependencies of the components, which may also be executed in furtherance of the requests. A latency of each component may be determined from its start-time and end-time, as well as the start-times and end-times of its dependencies. In some implementations, component latency may be analyzed on a per-request basis.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational environment in an implementation of enhanced component latency tracking.

FIG. 2 illustrates a latency tracking process in an implementation.

FIG. 3 illustrates an operational sequence in an implementation.

FIG. 4 illustrates another operational environment in an implementation of enhanced component latency tracking.

FIG. 5 illustrates an operational scenario in an implementation.

FIG. 6 illustrates an operational scenario in an implementation.

FIG. 7 illustrates an operational scenario in an implementation.

FIGS. 8A-8C illustrate latency analysis tables in an implementation.

FIG. 9 illustrates a computing system suitable for implementing the component latency tracking technology disclosed herein, including any of the architectures, environments, elements, processes, and operational scenarios and sequences illustrated in the Figures and discussed below in the Technical Disclosure.

### TECHNICAL DISCLOSURE

Technology is disclosed herein for tracking and analyzing component latency in software applications and services. For a given component in a software application or service, latency may be produced by the component's own business logic or from its dependencies. Tracking methods disclosed herein take timestamps on the start and end of each component and dependency, allowing for the latency of a component to be defined in slices. A slice is either the latency of the component or the latency of its dependency.

In addition, the latency tracking methods may record call stacks, such that latency can be attributed back to specific methods in a dependency or component. When the corresponding data are aggregated via a request ID from all of a component's dependencies, a full picture may be provided of how latencies add up and which methods and dependencies contribute to the latency. Analyzing slices with call stacks informs the user about which part of a component's code is costly. This may aid in the identification of hidden dependency or code issues and the determination of whether a dependency call is necessary and efficient. Slices may be compared between different builds, allowing for regressions and code fixes.

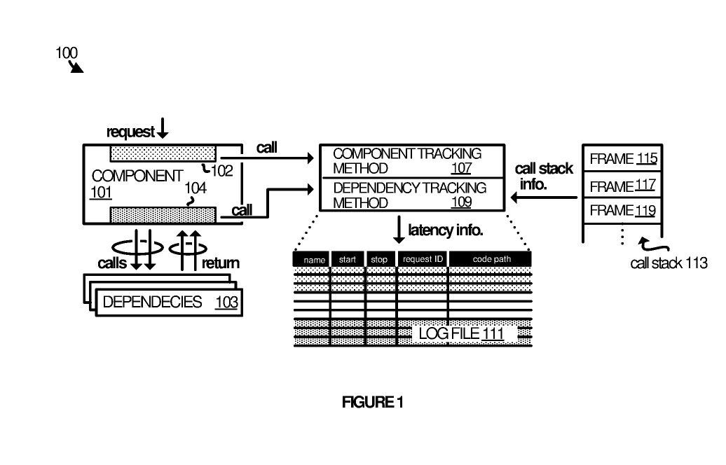

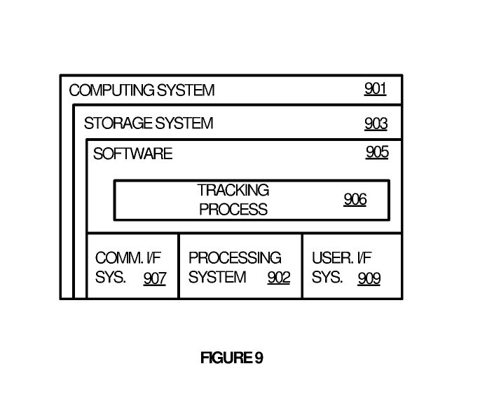

FIG. 1 illustrates an operational environment 100 in an implementation of enhanced component latency tracking and analysis. Operational environment 100 includes a component 101 and its dependencies 103. Operational environment 100 also includes various tracking methods, represented by component tracking method 107 and dependency tracking method 107. Operational environment 100 may be implemented on one or more computing systems, of which computing system 900 in FIG. 9 is representative.

Component 101 is representative of any program element, module, object, class, or other such portion of a software application that may be executed by one or more processors in the context of the application. Component 101 may include various methods, routines, or other sub-components that may be executed in the context of the component. In addition, component 101 includes a boundary point 102 and a boundary point 104 that represent the boundaries of the component. Boundary point 102 represents an entry point into component 101. Boundary point 104 represents an exit point from which component 101 may call one or more of dependencies 103.

Dependencies 103 represent the various components, services, or other such resources that component 101 may call and that return programmatic control to component 101 after completing. Some or all of dependencies 103 may execute locally in the same runtime environment relative to component 101, while others may execute remotely relative to the runtime environment of component 101.

Component tracking method 107 is representative of a method that may be called at the entry point to component 101 in order to timestamp the start-time and end-time of component 101. In contrast, dependency tracking method 104 is a method or function also called by component 101, but at the exit of component 101, to timestamp the start-time and end-time of dependencies 103.

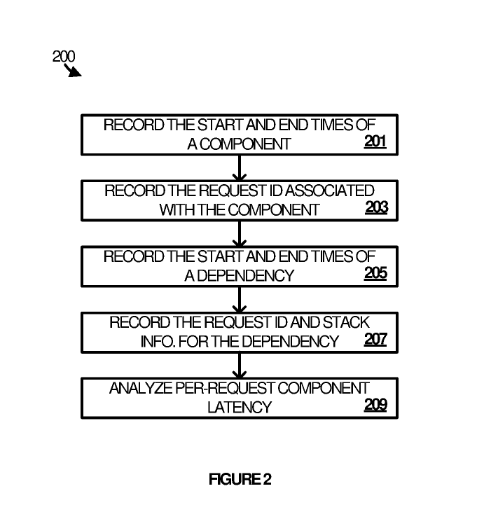

Component tracking method 107 and dependency tracking method 107 are utilized to track the latency of program components in accordance with tracking process 200, illustrated with respect to FIG. 2. Call stack 113 may be accessed by dependency tracking method 107 to obtain stack information associated with a component being tracked. Call stack 113 includes various frames, represented by frame 115, frame 117, and frame 119, each of which may hold information descriptive of the components and methods being executed in the runtime environment. Log file 111 is representative of one or more files, databases, or other such data structures to which latency information may be written and stored.

Tracking process 200 may be implemented in program instructions in the context of a software application or applications, modules, components, or other such programming elements to which component 101 belongs. The program instructions direct the underlying physical or virtual computing system or systems that execute the code to operate as follows.

Referring parenthetically to the steps illustrated in FIG. 2, the code records the start-time of a component at its entry point and the end-time of the component when it returns programmatic control the component or service that called it (Step 201). The code also records the timestamps in log file 111. In addition, the code records a request identifier for the component in association with each timestamp (step 203).

The subject component may call one or more dependencies during its operation. The code records the start-time and end-time of each dependency (step 205) in log file 111 and also records the request identifier and call stack information associated with each dependency in log file 111 (step 207).

With the request identifier, call stack information, and timestamps recorded in log file 111 for each component and dependency, the code may the identify the latency for each component on a per-request basis (step 209). The code may calculate the latency automatically each time a component runs, periodically, or at some other interval. In some implementations, some other service, utility, or other such program may perform the step of identifying the latency of a given component.

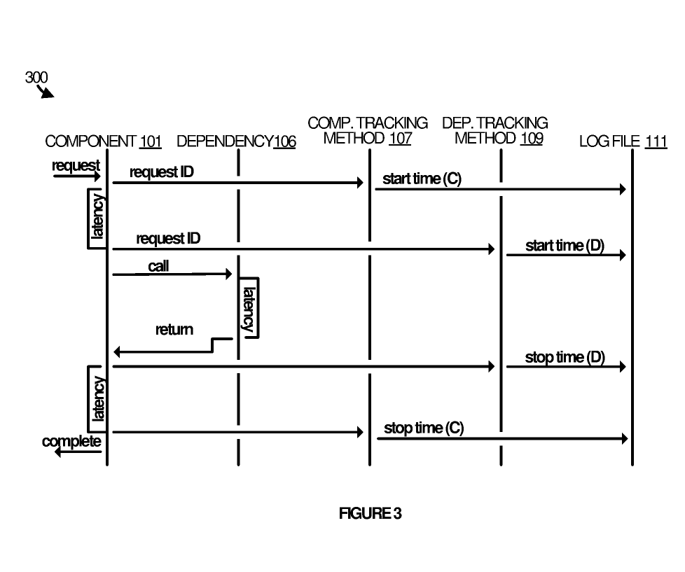

FIG. 3 illustrates an operational sequent 300 in one implementation. In operation, component 101 is called by another component, program, or service, in the context of fulfilling a request. Component 101 immediately calls component tracking method 107 and passes a request identifier to component tracking method 107. Component tracking method 107 logs the start-time of component 101 in log file 111.

Component 101 proceeds to execute its own logic in furtherance of the request. Executing its logic takes time, and as such, incurs latency. At some point in the execution of the logic, component 101 may be driven by the logic to call a dependency. At that point, component 101 calls into dependency tracking method 107 and passes the same request identifier to dependency tracking method 107. Dependency tracking method 107 logs the start-time of the dependency in association with the request identifier and call stack information. The call stack information may indicate, for example, which method or routine within component 101 was being run at the time of the dependency call.

Dependency 106 is called in this scenario, which is representative of one of the dependencies 103 in FIG. 1. Dependency 106 proceeds to execute its own logic, at the completion of which it returns programmatic control to component 101. Component 101 calls dependency tracking method 109 again so that dependency tracking method 109 can log the end-time of dependency 106.

Component 101 proceeds to execute the remainder of its logic once dependency 106 has completed. This may involve calling one or more other dependencies, in which case the same series of steps would be performed with respect to invoke 109. Component 101 eventually completes its routines and calls component tracking method 107. Component tracking method 107 logs the end-time of component 101, at which point component 101 can return control to which component had called it.

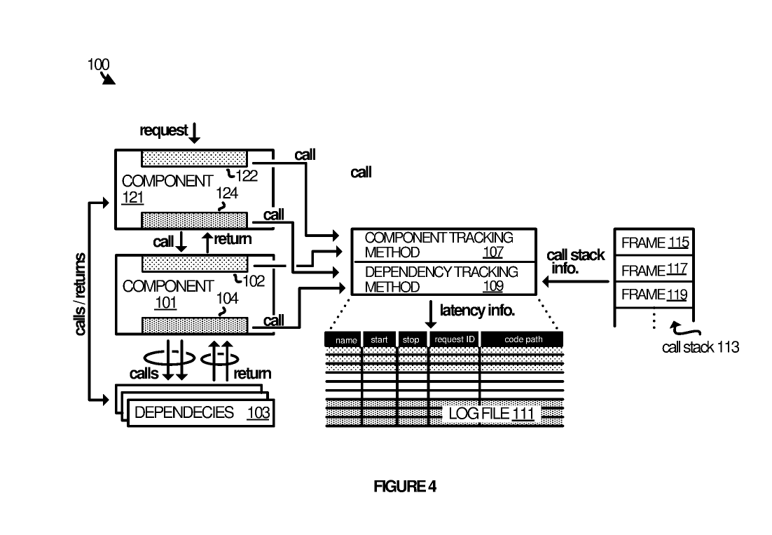

FIG. 4 illustrates an operational environment 400 in another implementation of enhanced component latency tracking and analysis. Operational environment 400 includes the same elements as operational environment 100, with the addition of component 121. Component 121 is representative of a component that may be called to service a request, during the fulfillment of which component 101 is called by the internal logic of component 121. The boundaries of component 121 (boundary point 122 and boundary point 124) may be instrumented in the same manner as those of component 101, such that they call component tracking method 107 and dependency tracking method 109.

In the aggregate, instances of component tracking method 107 and dependency tracking method 109 track both the start and end-times of component 121 and component 101. The request identifier associated with each instance of the components is stored in log file 111. This allows the latency of component 101 to be analyzed on a per-request basis, as component 101 may be called by component 121 (or any other component) in furtherance of other requests.

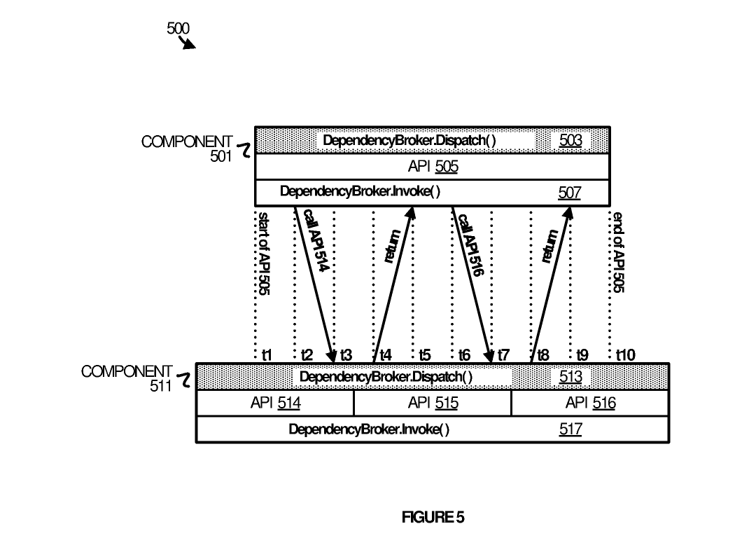

FIG. 5 illustrates an operational scenario 500 in one implementation of enhanced latency tracking. Operational scenario 500 relates to component 501 and component 511. Component 501 includes an application programming interface through which it may communicate with other components, applications, or services, represented by API 505. Component 511 includes several application programming interfaces, represented by API 514, API 515, and API 516.

Component 501 also includes a code section 503 that calls the method “DependencyBroker.Dispatch( )” at the entry to component 501. Component 511 includes a code section 513 at its entry point that also calls DependencyBroker.Dispatch( ). Similarly, code section 507 in component 501 calls DependencyBroker.Invoke( ) when utilizing dependencies. Code section 517 in component 511 also calls DependencyBroker.Invoke( ).

In operation, API 505 may be called by some other component, program, or service, at which time code section 503 invokes DependencyBroker.Dispatch( ) to track the latency of component 501. The internal logic of component 501 runs from time t1-t2, at which time a call is made to API 514 of component 511.

DependencyBroker.Invoke( ) is invoked at this moment to track the start and end-time of API 514, which duration of which lasts from t2-t5. In addition, DependencyBroker.Dispatch ( ) is called by component 511 at its entry point, so that the actual latency of component 511 may be tracked. Component 511 executes from t3-t4 and the corresponding timestamps for component 511 are logged.

The internal business logic of component 501 executes again from t5-t6, at which time another call is made to component 511, and to API 516 specifically. DependencyBroker.Invoke( ) is utilized again to track the overall latency of the dependency, while component 511 utilized DependencyBroker.Dispatch( ) to track its internal latency, which may include its own dependency calls, which would be tracked by code section 517.

Component 511 executes the second time from t7 to t8, at which time control is returned to component 501. DependencyBroker.Invoke( ) logs the end-time of API 516 and allows the remainder of component 501 to execute. Component 501 eventually completes and its end-time is logged by DepdendencyBroker.Dispatch( ).

It may be appreciated from the foregoing scenario that the actual time need to run the business logic of each component can be calculated by accounting for the transit time of dependency calls and the actual latency of dependencies. For example, component 101 actually executes from t1-t2, t5-t6, and t9-10, or for only 3 units of time, total. The API calls made by component utilized 4 unites of time, whereas the business logic of component 511 utilized only 2 units of time. The consistent logging of the start and end-times of both the components and dependencies by both latency methods allow for a more granular view of latency, rather than a view of component 501 that negates the latencies involved in API calls and the latencies involved in dependencies.

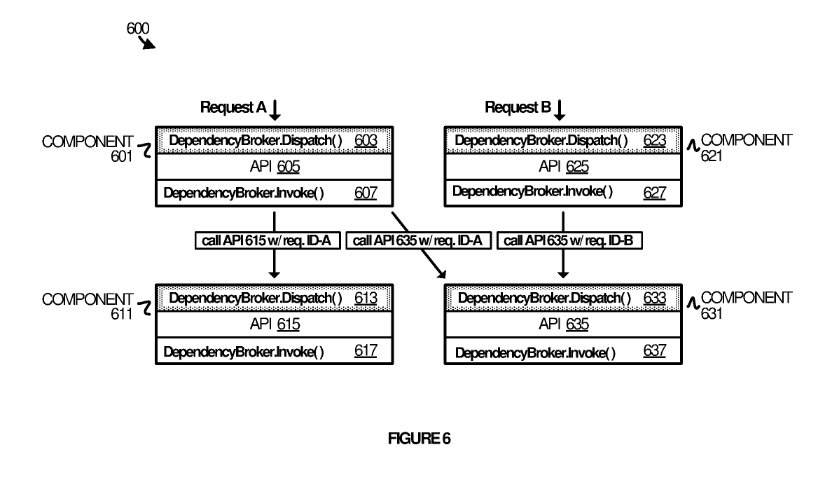

FIG. 6 illustrates an operational scenario 600 in an implementation. Operational scenario 600 includes component 601, component 611, component 621, and component 631. Component 601 includes a code section 603 that calls a component tracking method when API 605 is invoked and a code section 607 that calls a dependency tracking method when a dependency is called. Component 611 includes a code section 613 that calls a component tracking method when API 615 is invoked and a code section 617 that calls a dependency tracking method when a dependency is called. Component 621 includes a code section 623 that calls a component tracking method when API 625 is invoked and a code section 627 that calls a dependency tracking method when a dependency is called. Finally, component 631 includes a code section 633 that calls a component tracking method when API 635 is invoked and a code section 637 that calls a dependency tracking method when a dependency is called.

In operation, component 601 may be called by another component, application, or service, and executes in furtherance of a request (A). Code section 603 calls the component tracking method and passes a request ID-A so that its timestamps can be logged in association with the request. When component 601 calls API 615 in component 611, the same request ID-A is passed as a parameter, allowing code section 613 to pass the request ID-A to its own instance of the component tracking method. The dependency tracking method called by code section 607 can also log the same request ID-A in association with API 615.

Component 601 also calls API 635 in component 631. Code section 607 passes the request ID-A to the dependency tracking method in order to log its perceived latency of API 635 in a log file. However, code section 633 also passes the same request ID-A to its instance of the component tracking method, so that its own latency can be tracked in association with the request.

A different request (B) may be submitted to component 621. Code section 623 invokes the component tracking method and passes request ID-B so that the latency of component 621 can be tracked in association with that request. Component 621 may call API 635 in component 631 and, in so doing, pass the request ID-B to the dependency tracking method and component 631. The dependency tracking method spawned by code section 627 tracks the latency of component 621 in association with request ID-B, while the component tracking method called by code section 633 tracks the latency of component 631 in association with request ID-B.

In this manner, an analysis of the relative latency of component 631 with respect to different request identifiers may be made, as its latency information will be logged in association with both request ID-A and request ID-B.

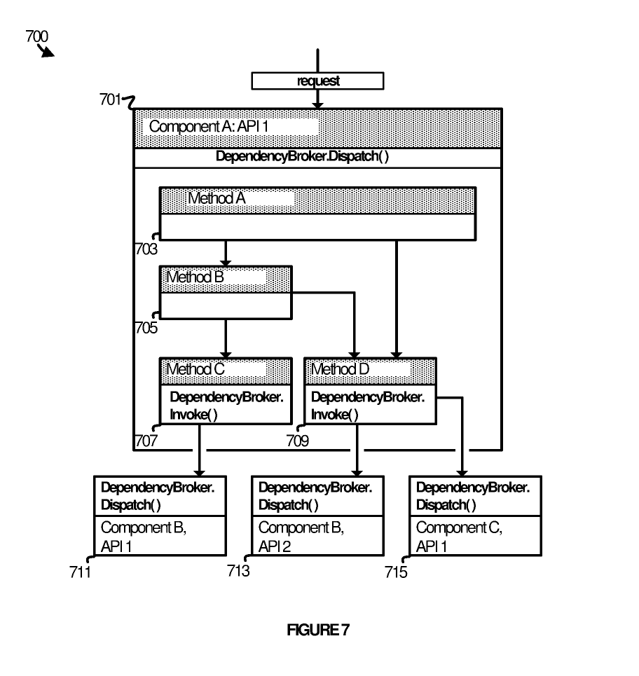

FIG. 7 illustrates yet another operational scenario 700 in an implementation of enhanced latency tracking. Operational scenario 700 involves a component A that includes various code sections represented by code section 701, code section 703, code section 705, code section 707, and code section 709.

Code section 701 is the entry point to component A. When component A is called, code section 701 executes, including by calling a component tracking method to track the start and end-time of component A.

At some point during its operation, method A in code section 703 may be called. Method A may be capable of calling either method B or method D, and possible other methods, depending on its own internal logic. Method B in code section 705 may call method C in code section 707. Method B may also call method D in code section 709.

Method C and method D represent exit points from component A to other components, such as component B and component C. In this scenario, method C may call component B as a dependency. In so doing, method C utilizes a dependency tracking method to log the start and end time of the dependency. Method D may also call component B as a dependency, as well as component C. In so doing, method D also utilizes a dependency tracking method to log the start and end times of the dependencies.

The dependencies themselves may also implement a component tracking method. Code section 711 in component B calls the component racking method when it is called by method C. Likewise, code section 713 and code section 715 in component B and component C respectively call the component tracking method when called by method D.

The resulting information that is logged allows the latencies of component A to be analyzed on a per-method or per-dependency basis. With call stacks, dependency calls can be aggregated per call stack to average out outliers. Since the logged information includes the latency slice of each method in a call stack, non-dependency and dependency latencies can be calculated for any method on the call stacks. If latency is from a component's own code and not from an apparent dependency, there may be some hidden dependencies that need to be called out or the code itself may not efficient. If latency is from a component's dependency, analysis can turn to the dependent component.

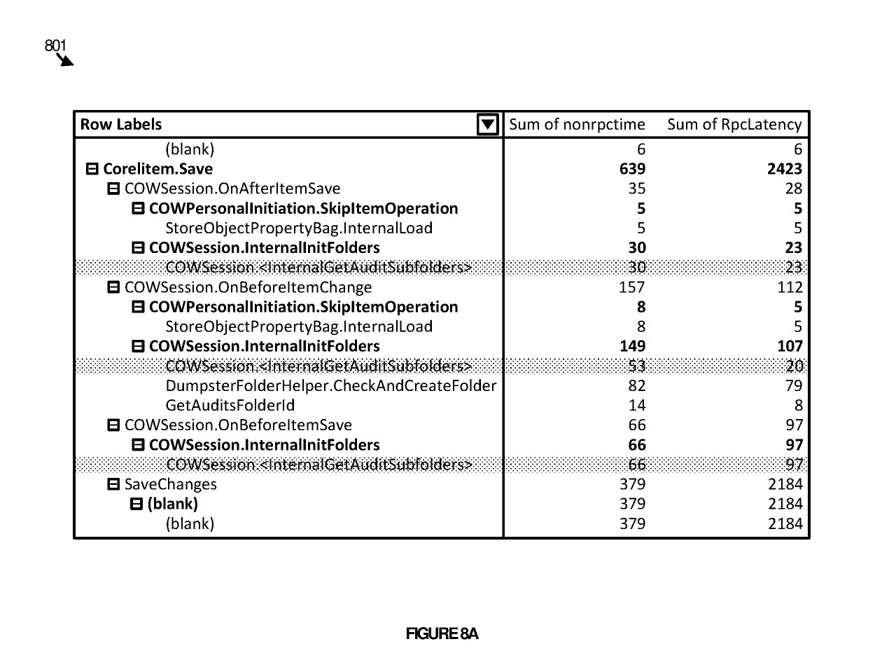

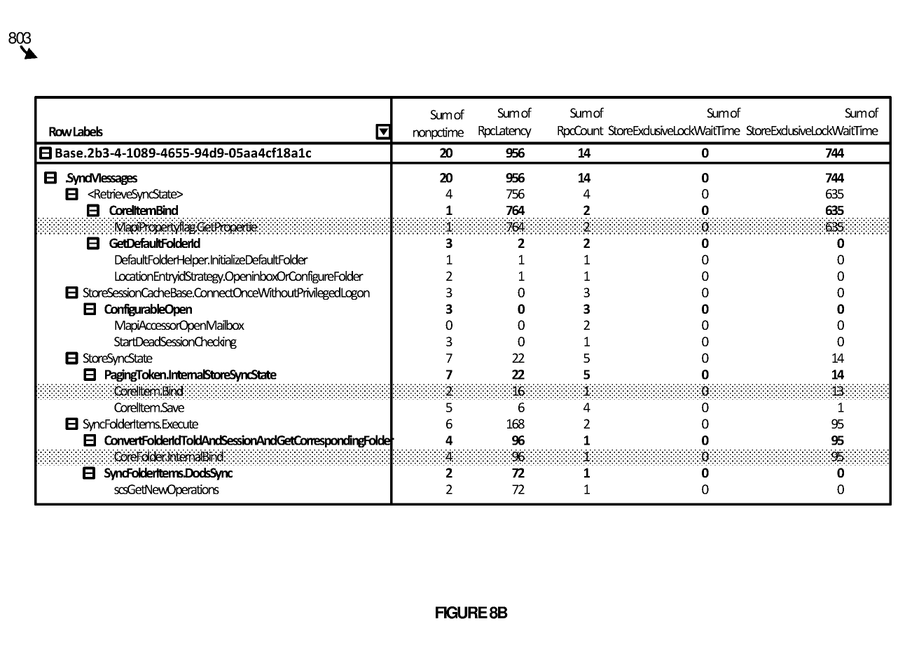

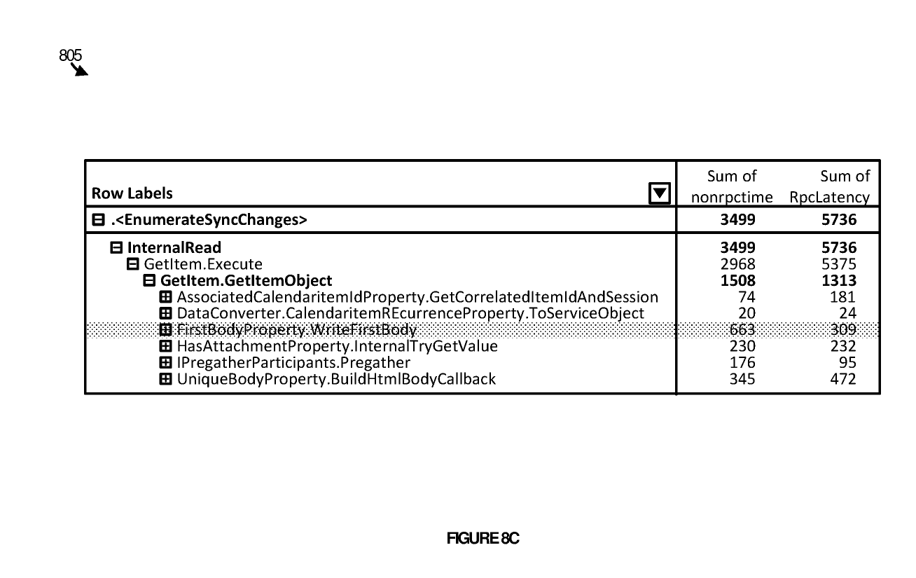

FIG. 8 illustrates an analysis 801 of the Exchange Sync API where RPC calls are dependency calls, after non-RPC latencies and RPC latencies are added up (sum of 276 requests to eliminate outlier noises) per call stack. The analysis shows that a majority of non-dependency latency (663 ms) is from WriteFirstBody.

Since any request can be tracked within and across components using request identifiers, from non-dependency and dependency latencies calculation, there are two actions that can be taken. Latencies can be narrowed down into a few slices to identify where latencies are coming from. In addition, a determination can be made if dependency calls are necessary and efficient by identifying calling pattern and by code inspection. For example, in an analysis 803 in FIG. 8B of the Exchange Sync API, it shows for a request that RPC latency is coming from lock wait time.

FIG. 8C shows in an analysis 805 that InternalGetAuditSubfolders is called three times under CoreItem.Save( ). Thus, this dependency becomes a good candidate to examine further with respect to reducing latencies and avoiding unnecessary dependencies.

FIG. 9 illustrates computing system 901, which is representative of any system or collection of systems in which the various applications, services, scenarios, and processes disclosed herein may be implemented. Examples of computing system 901 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 901 may be implemented as a single apparatus, system, or device or may be implemented in a distributed manner as multiple apparatuses, systems, or devices. Computing system 901 includes, but is not limited to, processing system 902, storage system 903, software 905, communication interface system 907, and user interface system 909. Processing system 902 is operatively coupled with storage system 903, communication interface system 907, and user interface system 909.

Processing system 902 loads and executes software 905 from storage system 903. Software 905 includes tracking process 906, which is representative of the processes discussed with respect to the preceding FIGS. 1-8, including tracking process 200. When executed by processing system 902 to enhance latency tracking, software 905 directs processing system 902 to operate as described herein for at least the various processes, operational scenarios, and sequences discussed in the foregoing implementations. Computing system 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device, but may also be distributed across multiple processing devices or sub-systems that cooperate in executing program instructions. Examples of processing system 902 include general purpose central processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or other suitable storage media, except for propagated signals. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device, but may also be implemented across multiple storage devices or sub-systems co-located or distributed relative to each other. Storage system 903 may comprise additional elements, such as a controller, capable of communicating with processing system 902 or possibly other systems.

Software 905 may be implemented in program instructions and among other functions may, when executed by processing system 902, direct processing system 902 to operate as described with respect to the various operational scenarios, sequences, and processes illustrated herein. For example, software 905 may include program instructions for implementing tracking processes 200.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtual machine software, or other application software, in addition to or that include tracking process 906. Software 905 may also comprise firmware or some other form of machine-readable processing instructions executable by processing system 902.

In general, software 905 may, when loaded into processing system 902 and executed, transform a suitable apparatus, system, or device (of which computing system 901 is representative) overall from a general-purpose computing system into a special-purpose computing system enhance component latency tracking. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 909 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 909. In some cases, the input and output devices may be combined in a single device, such as a display capable of displaying images and receiving touch gestures. The aforementioned user input and output devices are well known in the art and need not be discussed at length here.

User interface system 909 may also include associated user interface software executable by processing system 902 in support of the various user input and output devices discussed above. Separately or in conjunction with each other and other hardware and software elements, the user interface software and user interface devices may support a graphical user interface, a natural user interface, or any other type of user interface.

Communication between computing system 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A computing apparatus comprising:
one or more computer readable storage media;
a processing system operatively coupled with the one or more computer readable storage media; and
program instructions stored on the one or more computer readable storage media for tracking component latency that, when read and executed by the processing system, direct the processing system to at least:
record start-times and end-times of components executed in furtherance of requests for services that utilize at least some of the components;
record the start-times and the end-times of dependencies of the components also executed in furtherance of the requests; and
record an identity of each of the requests for services in association with each of the components and each of the dependencies to allow for an analysis of latency of each of the components on a per-request basis based at least on a start-time and an end-time of a given component and the start-times and end-times of those of the dependencies called by the given component in the context of a given request.

2. The computing apparatus of claim 1 wherein the program instructions further direct the processing system to call a component tracking method at an entry point to each of the components in order to record a start-time and an end-time of the given component.

3. The computing apparatus of claim 2 wherein the program instructions further direct the processing system to call a dependency tracking method of each of the components at a boundary between the given component and a dependency in order to record a start-time and an end-time of the dependency.

4. The computing apparatus of claim 1 wherein the program instructions further direct the processing system to record call stacks in association with the start-times and the end-times of the dependencies of the components.

5. The computing apparatus of claim 4 wherein the latency tracking service directs the processing system to record identities of the requests in association with the start-times and the end-times of the components.

6. The computing apparatus of claim 1 wherein the dependencies comprise remote procedure calls.

7. The computing apparatus of claim 6 wherein the services comprise a find messages service for finding emails in an email repository.

8. One or more computer readable storage media having program instructions stored thereon for tracking component latency that, when read and executed by a processing system, directs the processing system to at least:
record start-times and end-times of components executed in furtherance of requests for services that utilize at least some of the components;
record the start-times and the end-times of dependencies of the components also executed in furtherance of the requests; and
record an identity of each of the requests for services in association with each of the components and each of the dependencies to allow for an analysis of latency of each of the components on a per-request basis based at least on a start-time and an end-time of a given component and the start-times and end-times of those of the dependencies called by the given component in the context of a given request.

9. The one or more computer readable storage media of claim 8 wherein the program instructions further direct the processing system to call a component tracking method at an entry point to each of the components in order to record a start-time and an end-time of the given component.

10. The one or more computer readable storage media of claim 9 wherein the program instructions further direct the processing system to call a dependency tracking method of each of the components at a boundary between the given component and a dependency in order to record a start-time and an end-time of the dependency.

11. The one or more computer readable storage media of claim 8 wherein the program instructions further direct the processing system to record call stacks in association with the start-times and the end-times of the dependencies of the components.

12. The one or more computer readable storage media of claim 11 wherein the latency tracking service directs the processing system to record identities of the requests in association with the start-times and the end-times of the components.

13. The one or more computer readable storage media of claim 8 wherein the dependencies comprise remote procedure calls.

14. The one or more computer readable storage media of claim 13 wherein the services comprise a find messages service for finding emails in an email repository.

15. A method for analyzing component latencies comprising:
recording start-times and end-times of components executed in furtherance of requests for services that utilize at least some of the components;
recording the start-times and the end-times of dependencies of the components executed in furtherance of the requests; and
recording an identity of each of the requests for services in association with each of the components and each of the dependencies to allow for an analysis of latency of each of the components on a per-request basis based at least on a start-time and an end-time of a given component and the start-times and end-times of those of the dependencies called by the given component in the context of a given request.

16. The method of claim 15 further comprising calling a component tracking method at an entry point to each of the components in order to record a start-time and an end-time of the given component.

17. The method of claim 16 further comprising calling a dependency tracking method of each of the components at a boundary between the given component and a dependency in order to record a start-time and an end-time of the dependency.

18. The method of claim 15 further comprising recording call stacks in association with the start-times and the end-times of the dependencies of the components.

19. The method of claim 15 wherein the dependencies comprise remote procedure calls.

20. The method of claim 19 wherein the services comprise a find messages service for finding emails in an email repository.
